(19) United States
(12) Patent Application Publication
(10) Pub. No.: US 2026/0039048 A1
(43) Pub. Date: Feb. 5, 2026

(54) TERMINAL

(71) Applicant: I-PEX Inc., Kyoto-shi, Kyoto (JP)

(72) Inventor: Seimu KAMADA, Machida-shi (JP)

(21) Appl. No.: 18/842,748

(22) PCT Filed: Feb. 22, 2023
(86) PCT No.: PCT/JP2023/006475

§ 371 Date: Mar. 6, 2025

(30) Foreign Application Priority Data
Mar. 3, 2022 (JP) 2022-032318

(51) Int. Cl. H01R 13/05

(52) U.S. Cl. CPC H01R 13/055

(57) ABSTRACT

In a plug terminal (1), a first plug elastic portion (13) connects a plug substrate connection portion (11) connected to a first substrate and a plug contact portion (12) that contacts a contact of a receptacle terminal. The first plug elastic portion (13) includes a first plug spring portion (30), a second plug spring portion (31), and a first coupling portion (32). The first plug spring portion (30) is provided along a first plug side surface (S11) being a part of side surfaces of a virtual first solid (C1) having, as a plane surface, a plug plane figure (B11) containing the plug contact portion (12) when viewed from an introduction-extraction direction, and is deformable with respect to the first plug side surface (S11). The second spring portion (31) is provided along a second plug side surface (S12) being a part of the side surfaces of the first solid (C1) and having a different normal direction from the first plug side surface (S11), and is deformable with respect to the second plug side surface (S12). The first coupling portion (32) couples the first plug spring portion (30) to the second plug spring portion (31).

### TECHNICAL FIELD

The present disclosure relates to a terminal.

### BACKGROUND ART

Patent Literature 1 discloses a receptacle contact acquired by bending a band-shaped metal piece. The receptacle contact includes a spring member, and can thus cause a contact member to follow a movement in a lateral direction (X-axis direction) of the other contact.

### CITATION LIST

### Patent Literature

Patent Literature 1: Japanese Patent No. 4880924

### SUMMARY OF INVENTION

### Technical Problem

In the receptacle contact (terminal) disclosed in Patent Literature 1 described above, a direction in which the spring member can be elastically deformed is mainly an X-axis direction, and is hardly elastically deformed in a Y-axis direction and a Z-axis direction. Thus, causing the contact member to follow a movement of the other terminal is limited.

The present disclosure has been made in view of the reasons described above, and has an objective to provide a terminal in which followability with respect to the other terminal can be improved.

### Solution to Problem

In order to achieve the objective described above, a terminal according to the present disclosure is a terminal made of a conductive material, and the terminal including:
a substrate connection portion connected to a substrate;
a contact portion that contacts a contact of other terminal being introduced and extracted in an introduction-extraction direction crossing a main surface of the substrate; and
a first elastic portion that connects the substrate connection portion and the contact portion,
wherein the first elastic portion includes
   a first spring portion that is provided along a first side surface being a part of side surfaces of a virtual solid having, as a plane surface or a bottom, a plane figure containing the contact portion when viewed from the introduction-extraction direction, and that is deformable with respect to the first side surface,
   a second spring portion that is provided along a second side surface being a part of the side surfaces of the solid and having a different normal direction from the first side surface, and that is deformable with respect to the second side surface, and
   a first coupling portion that couples the first spring portion to the second spring portion.

The terminal may further include
a second elastic portion that connects the substrate connection portion and the contact portion,
wherein the second elastic portion may include
   a third spring portion that is provided along a third side surface being a part of the side surfaces of the solid and facing the first side surface, and that is deformable with respect to the third side surface,
   a fourth spring portion that is provided along a fourth side surface being a part of the side surfaces of the solid and facing the second side surface, and that is deformable with respect to the fourth side surface, and
   a second coupling portion that couples the third spring portion to the fourth spring portion.

The terminal may further include a contact connection portion that connects the first elastic portion and the second elastic portion to the contact portion,
wherein the contact connection portion may be divided into a first connection portion connected to the first elastic portion and a second connection portion connected to the second elastic portion by a slit extending from the substrate connection portion toward the contact portion along the introduction-extraction direction.

The first elastic portion and the second elastic portion may be disposed in a point symmetry with the contact portion as the center when viewed from the introduction-extraction direction.

The terminal may have an S-shape when viewed from the introduction-extraction direction.

### Advantageous Effects of Invention

According to the present disclosure, the first elastic portion that connects the substrate connection portion and the contact portion includes the first spring portion that is deformable with respect to the first side surface being a part of the side surfaces of the virtual solid having, as the plane surface or the bottom, the plane figure containing the contact portion when viewed from the introduction-extraction direction with the other terminal, and a second spring portion that is deformable with respect to the second side surface having a different normal direction from the first side surface. In this way, a relative position of the terminal with respect to the substrate connection portion can deviate in two directions crossing the introduction-extraction direction with the other terminal. Thus, followability with respect to the other terminal can be improved.

### BRIEF DESCRIPTION OF DRAWINGS

FIG. 1A is a first perspective view of a plug terminal according to Embodiment 1 of the present disclosure;

FIG. 1B is a second perspective view of the plug terminal according to Embodiment 1 of the present disclosure;

FIG. 2 is a plan view of the plug terminal in FIG. 1A before bending processing is performed;

FIG. 3A is a first perspective view of a plug terminal, and illustrates a virtual solid being a reference to the bending processing;

FIG. 3B is a second perspective view of the plug terminal, and illustrates the virtual solid being the reference to the bending processing;

FIG. 4 is a hexahedral view of the plug terminal in FIG. 1A;

FIG. 5 is a schematic view of a simplified structure of the plug terminal in FIG. 1A;

FIG. 6A is a first perspective view of a receptacle terminal according to Embodiment 1 of the present disclosure;

FIG. 6B is a second perspective view of the receptacle terminal according to Embodiment 1 of the present disclosure;

FIG. 7 is a plan view of the receptacle terminal in FIG. 6A before the bending processing is performed;

FIG. 8A is a first perspective view of the receptacle terminal illustrated in FIG. 6A, and illustrates a virtual solid being a reference to the bending processing;

FIG. 8B is a second perspective view of the receptacle terminal illustrated in FIG. 6A, and illustrates the virtual solid being the reference to the bending processing;

FIG. 9 is a hexahedral view of the receptacle terminal in FIG. 6A;

FIG. 10 is a schematic view of a simplified structure of the receptacle terminal in FIG. 6A;

FIG. 11A is a first perspective view illustrating a scene where the plug terminal in FIG. 1A and the receptacle terminal in FIG. 6A are fitted;

FIG. 11B is a second perspective view illustrating a scene where the plug terminal in FIG. 1A and the receptacle terminal in FIG. 6A are fitted;

FIG. 11C is a side view when the plug terminal in FIG. 1A and the receptacle terminal in FIG. 6A are fitted;

FIG. 11D is a cross-sectional view taken along an XI-XI line in FIG. 11C;

FIG. 12 is a view illustrating an example 1 in which the plug terminal in FIG. 1A and the receptacle terminal in FIG. 6A are fitted;

FIG. 13 is a view illustrating an example 2 in which the plug terminal in FIG. 1A and the receptacle terminal in FIG. 6A are fitted;

FIG. 14A is a first perspective view of a receptacle terminal according to Embodiment 2 of the present disclosure;

FIG. 14B is a second perspective view of the receptacle terminal according to Embodiment 2 of the present disclosure;

FIG. 15 is a plan view of the receptacle terminal in FIG. 14A before the bending processing is performed;

FIG. 16A is a first perspective view of the receptacle terminal illustrated in FIG. 14A, and illustrates a virtual solid being a reference to the bending processing;

FIG. 16B is a second perspective view of the receptacle terminal illustrated in FIG. 14A, and illustrates the virtual solid being the reference to the bending processing;

FIG. 17 is a hexahedral view of the receptacle terminal in FIG. 14A;

FIG. 18A is a first perspective view illustrating a scene where the plug terminal in FIG. 1A and the receptacle terminal in FIG. 14A are fitted;

FIG. 18B is a second perspective view illustrating a scene where the plug terminal in FIG. 1A and the receptacle terminal in FIG. 14A are fitted;

FIG. 18C is a side view when the plug terminal in FIG. 1A and the receptacle terminal in FIG. 14A are fitted;

FIG. 18D is a cross-sectional view taken along an XVIII-XVIII line in FIG. 18C;

FIG. 19 is a perspective view of a receptacle terminal according to Embodiment 3 of the present disclosure; and

FIG. 20 is a hexahedral view of the receptacle terminal in FIG. 19.

### DESCRIPTION OF EMBODIMENTS

Hereinafter, embodiments of the invention of the present application are described in detail with reference to drawings. The same or equivalent portion is denoted by the same reference sign in each of the drawings.

### Embodiment 1

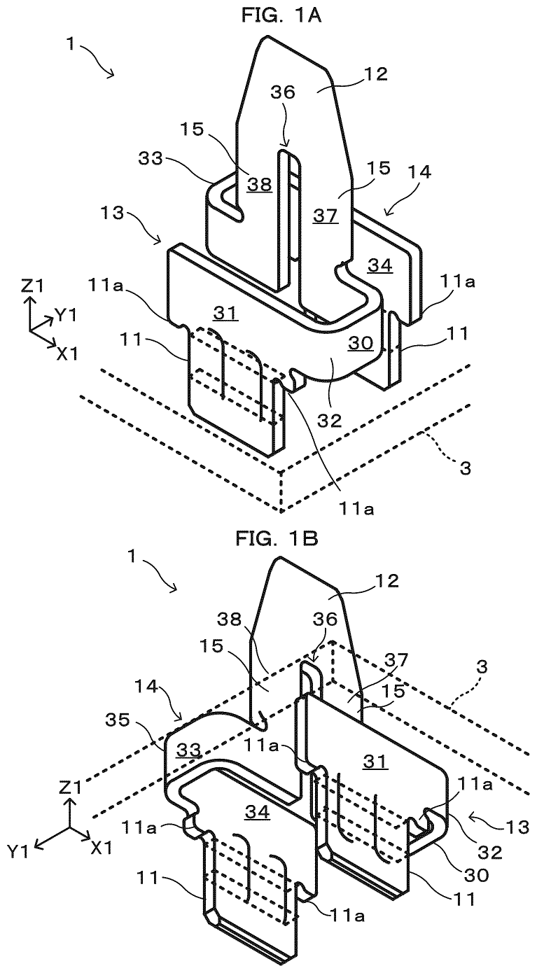

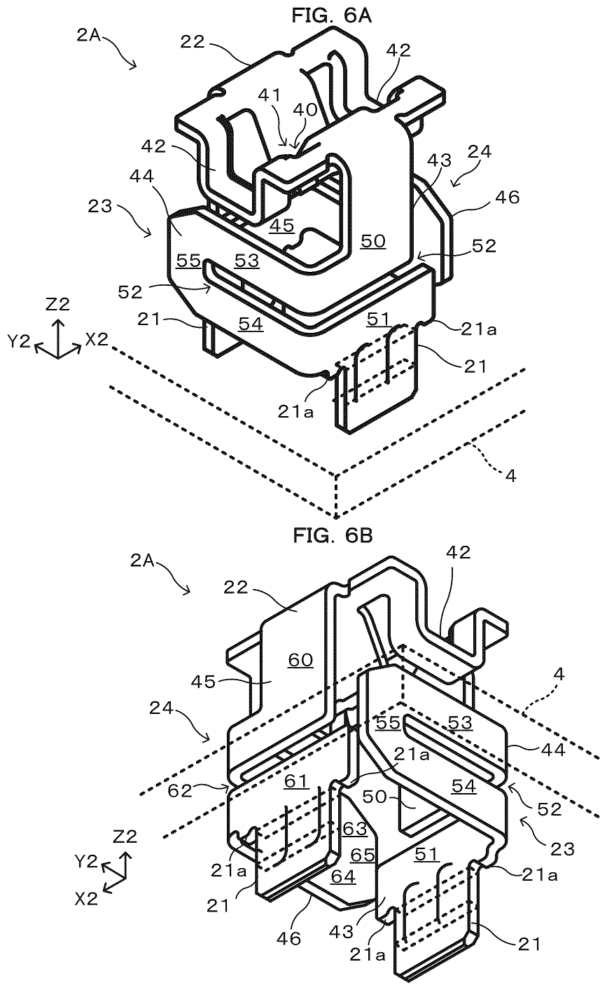

First, Embodiment 1 of the present disclosure is described. In the present embodiment, two terminals that are connected to each other and can transmit a signal between substrates are described. The two terminals are a plug terminal 1 illustrated in FIGS. 1A and 1B and a receptacle terminal 2A illustrated in FIGS. 6A and 6B.

### [Plug Terminal]

First, the plug terminal 1 is described. As illustrated in FIGS. 1A and 1B, the plug terminal 1 is mounted on a first substrate 3. In FIGS. 1A and 1B, the first substrate 3 is indicated by a dotted line. In the present embodiment, the plug terminal 1 is described with reference to a three-axis orthogonal coordinate system including an X1-axis, a Y1-axis, and a Z1-axis. Herein, the X1-axis and the Y1-axis are defined as in-plane directions of a main surface of the first substrate 3. The Z1-axis is defined as a normal direction of the main surface of the first substrate 3.

The plug terminal 1 is connected to the receptacle terminal 2A (see FIGS. 6A and 6B) mounted on a second substrate 4 described below, and is used for transmission of an electric signal or grounding between the first substrate 3 and the second substrate 4.

The plug terminal 1 is made of a conductive material, for example, metal. As the material, for example, a copper alloy is used. As the copper alloy, there are, for example, beryllium copper, phosphor bronze, and titanium copper.

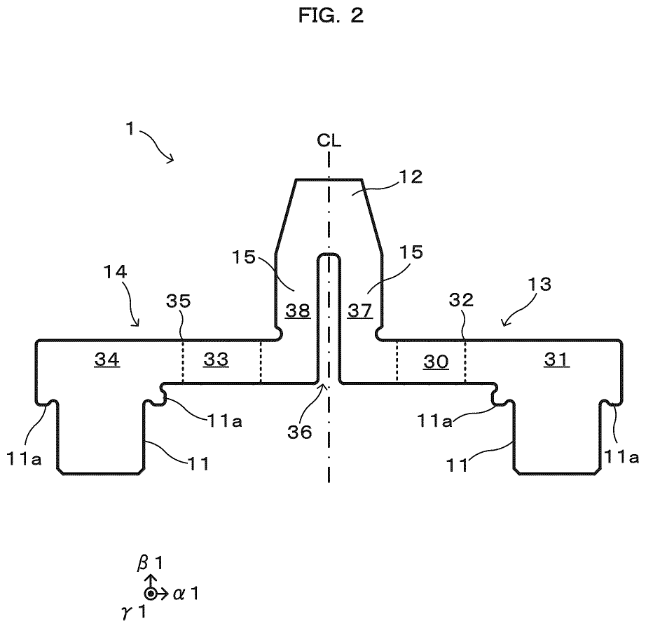

The plug terminal 1 is acquired by performing punching and bending processing on a metal plate having elasticity. Specifically, the plug terminal 1 is processed into a shape illustrated in FIG. 2 by the punching processing on the metal plate having elasticity. In-plane directions of the metal plate are an α1-axis and a β1-axis, and a plate thickness of the metal plate is a γ1-axis. The metal plate has a line-symmetric shape with respect to a central line CL parallel to the β1-axis. After the punching processing, the metal plate is bent at a portion of a broken line by the bending processing, and has a shape illustrated in FIGS. 1A and 1B. The metal plate has a plate thickness of, for example, about 0.5 mm, which is not limited thereto.

Returning to FIGS. 1A and 1B, the plug terminal 1 includes a plug substrate connection portion 11, a plug contact portion 12, a first plug elastic portion 13, a second plug elastic portion 14, and a plug contact connection portion 15.

### [Plug Substrate Connection Portion]

The plug substrate connection portion 11 is connected to the first substrate 3. In the present embodiment, a pair of the plug substrate connection portions 11 is provided. The first substrate 3 has a rectangular through hole, and the plug substrate connection portion 11 is put into the through hole and is soldered. In this way, the plug substrate connection portion 11 is mounted on the main surface of the first substrate 3. The plug terminal 1 is provided with a plug positioning portion 11a around the plug substrate connection portion 11 in such a way as to prevent the plug terminal 1 from being mounted obliquely to the first substrate 3. An electronic part is mounted on the main surface of the first substrate 3, and an electric circuit including the electronic part is constructed. An electrode is connected to the electric circuit, and the plug substrate connection portion 11 put into the through hole is connected to the electrode.

### [Plug Contact Portion]

The plug contact portion 12 contacts a receptacle contact portion 22 (see FIGS. 6A and 6B) of the receptacle terminal 2A described below. As illustrated in FIGS. 1A and 1B, the plug contact portion 12 is a protruding contact that protrudes in the +Z1 direction. In the present embodiment, the Z1-axis direction is an introduction-extraction direction in which the plug contact portion 12 is introduced into and extracted from the receptacle contact portion 22 of the receptacle terminal 2A. A size of the plug contact portion 12, for example, a length in the Z1-axis direction is determined in consideration of a position deviation amount (floating amount) permissible between the receptacle contact portion 22 of the receptacle terminal 2A and the plug contact portion 12. A permissible position deviation amount is, for example, 1.0 mm, which is not limited thereto. A length in the Z1-axis direction of the plug contact portion 12 is, for example, 4.0 mm, which is not limited thereto.

### [First Plug Elastic Portion]

The first plug elastic portion 13 connects one plug substrate connection portion 11 of the pair of the plug substrate connection portions 11 to the plug contact portion 12. As illustrated in FIG. 2, the first plug elastic portion 13 is a band-shaped member extending in the α1-axis direction, includes one end on the +α1 side connected to the plug substrate connection portion 11, and includes another end on the −α1 side connected to the plug contact portion 12 via the plug contact connection portion 15.

The first plug elastic portion 13 includes a first plug spring portion 30, a second plug spring portion 31, and a first coupling portion 32. As illustrated in FIG. 2, in the first plug elastic portion 13, the first plug spring portion 30, the first coupling portion 32, and the second plug spring portion 31 are arranged in this order from the plug contact portion 12 side in the +α1 direction. The first plug elastic portion 13 has a shape illustrated in FIGS. 1A and 1B and acquired by being bent at 90 degrees at a broken line parallel to the β1-axis between the first plug spring portion 30 and the plug contact connection portion 15, and being further bent at 90 degrees at a broken line parallel to the β1-axis in the first coupling portion 32 that couples the first plug spring portion 30 to the second plug spring portion 31.

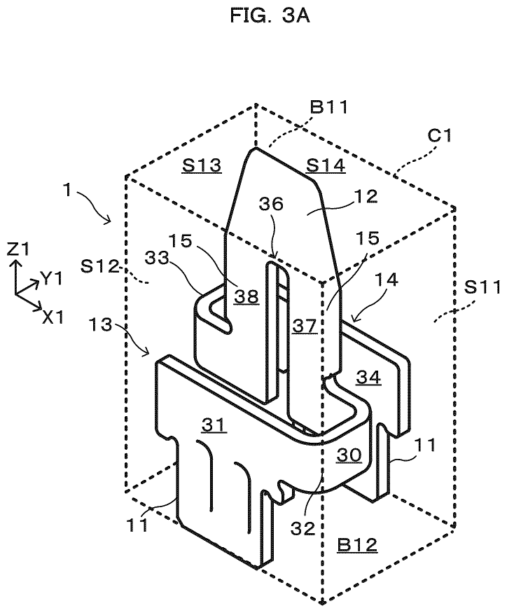

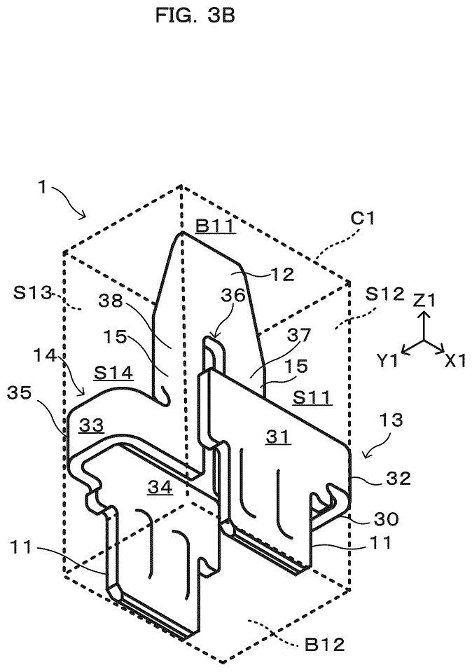

In the present embodiment, the first plug elastic portion 13 is bent with reference to a virtual first solid C1 illustrated in FIGS. 3A and 3B. The first solid C1 is a rectangular parallelepiped, that is, a quadrangular prism. The first solid C1 has, as a plane surface, a plug plane figure B11 containing the plug contact portion 12 when viewed from the introduction-extraction direction, and has a plug plane figure B12 as a bottom. The plug plane figures B11 and B12 have the Z1-axis direction as a normal direction. The first solid C1 includes, as apart of side surfaces of the first solid C1, a first plug side surface S11, a second plug side surface S12, a third plug side surface S13, and a fourth plug side surface S14. The first plug side surface S11 and the third plug side surface S13 have the X1-axis direction as a normal direction, and the second plug side surface S12 and the fourth plug side surface S14 have the Y1-axis direction as a normal direction. In this way, the first plug side surface S11 and the third plug side surface S13, and the second plug side surface S12 and the fourth plug side surface S14 have the different normal directions.

As illustrated in FIGS. 3A and 3B, the first plug spring portion 30 is provided along the first plug side surface S11 of the first solid C1. The first plug spring portion 30 has an elastic force, and is deformable with respect to the first plug side surface S11.

As illustrated in FIGS. 3A and 3B, the second plug spring portion 31 is provided along the second plug side surface S12 of the first solid C1. The second plug spring portion 31 is deformable with respect to the second plug side surface S12.

As illustrated in FIG. 3A, the first coupling portion 32 is provided in a position corresponding to a corner between the first plug side surface S11 and the second plug side surface S12. The first coupling portion 32 couples the first plug spring portion 30 to the second plug spring portion 31.

### [Second Plug Elastic Portion]

The second plug elastic portion 14 connects the other plug substrate connection portion 11 not being coupled to the first plug elastic portion 13 of the pair of the plug substrate connection portions 11 to the plug contact portion 12. As illustrated in FIG. 2, the second plug elastic portion 14 is a band-shaped member extending in the α1-axis direction, includes one end on the −α1 side connected to the plug substrate connection portion 11, and includes another end on the +α1 side connected to the plug contact portion 12 via the plug contact connection portion 15.

The second plug elastic portion 14 includes a third plug spring portion 33, a fourth plug spring portion 34, and a second coupling portion 35. As illustrated in FIG. 2, in the second plug elastic portion 14, the third plug spring portion 33, the second coupling portion 35, and the fourth plug spring portion 34 are arranged in this order from the plug contact portion 12 side in the −α1 direction. The second plug elastic portion 14 has a shape illustrated in FIGS. 1A and 1B and acquired by being bent at 90 degrees at a broken line parallel to the R 1-axis between the third plug spring portion 33 and the plug contact connection portion 15, and being further bent at 90 degrees at a broken line parallel to the R 1-axis in the second coupling portion 35 that couples the third plug spring portion 33 to the fourth plug spring portion 34.

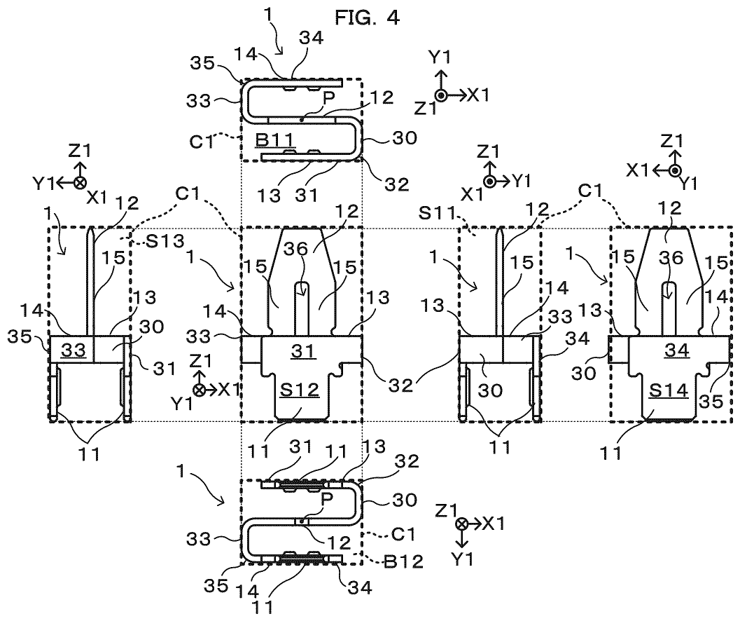

Similarly to the first plug elastic portion 13, the second plug elastic portion 14 is bent with reference to the virtual first solid C1 illustrated in FIGS. 3A, 3B, and 4.

As illustrated in FIGS. 3A, 3B, and 4, the third plug spring portion 33 is provided along the third plug side surface S13 that is a part of the side surfaces of the first solid C1 and faces the first plug side surface S11. The third plug spring portion 33 is deformable with respect to the third plug side surface S13.

As illustrated in FIGS. 3A, 3B, and 4, the fourth plug spring portion 34 is provided along the fourth plug side surface S14 that is a part of the side surfaces of the first solid C1 and faces the second plug side surface S12. The fourth plug spring portion 34 is deformable with respect to the fourth plug side surface S14.

As illustrated in FIGS. 3B and 4, the second coupling portion 35 is provided in a position corresponding to a corner between the first plug side surface S11 and the second plug side surface S12. The second coupling portion 35 couples the third plug spring portion 33 to the fourth plug spring portion 34.

### [Plug Contact Connection Portion]

The plug contact connection portion 15 connects the first plug elastic portion 13 and the second plug elastic portion 14 to the plug contact portion 12. As illustrated in FIG. 2, the plug contact connection portion 15 has a plug slit 36 extending from an outer side on the −β side toward the plug contact portion 12 along the introduction-extraction direction. The plug slit 36 extends to the plug contact portion 12. The plug slit 36 divides the plug contact connection portion 15 into a first connection portion 37 connected to the first plug elastic portion 13 and a second connection portion 38 connected to the second plug elastic portion 14.

FIG. 4 illustrates a hexahedral view of the plug terminal 1. As illustrated in FIG. 4, in a plan view and a bottom view of the plug terminal 1, the first plug elastic portion 13 and the second plug elastic portion 14 are disposed in a point symmetry with the plug contact portion 12 as the center, more accurately, a central point P of the plug contact portion 12 as the center when viewed from the introduction-extraction direction (Z1-axis direction). More specifically, the plug terminal 1 has an S-shape when viewed from the introduction-extraction direction. Still more specifically, the plug contact portion 12, the first plug elastic portion 13, and the second plug elastic portion 14 have an S-shape when viewed from the introduction-extraction direction.

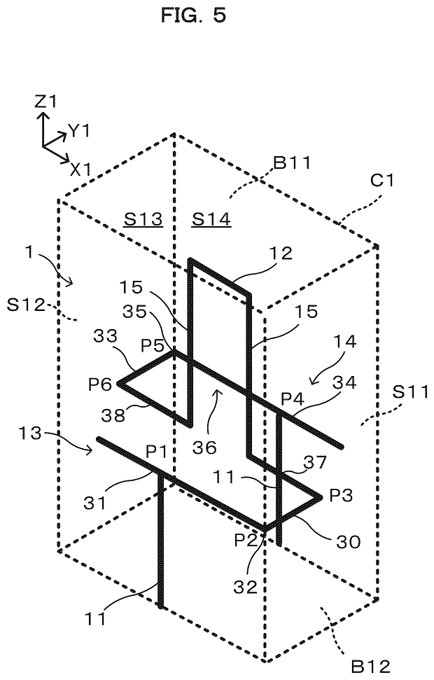

FIG. 5 illustrates a schematic view of a simplified structure of the first plug elastic portion 13 and the second plug elastic portion 14. FIG. 5 illustrates, as a linear member, the first plug spring portion 30 and the second plug spring portion 31 constituting the first plug elastic portion 13. FIG. 5 illustrates, as a linear member, the third plug spring portion 33 and the fourth plug spring portion 34 constituting the second plug elastic portion 14. The same applies to the plug substrate connection portion 11 and the plug contact portion 12.

A position of the plug substrate connection portion 11 connected to the first substrate 3 is fixed. However, the first plug elastic portion 13 and the second plug elastic portion 14 that connect the plug substrate connection portion 11 and the plug contact portion 12 have an elastic force, and are thus deformable by a force received from the plug contact portion 12.

More specifically, as illustrated in FIG. 5, the second plug spring portion 31 has such an elastic force that displaces a position P2 of an end portion connected to the first coupling portion 32 with respect to a position P1 connected to the plug substrate connection portion 11 in the X1-axis direction, the Y1-axis direction, and the Z1-axis direction. The first plug spring portion 30 has such an elastic force that displaces a position P3 of an end portion connected to the first connection portion 37 with respect to the position P2 of the first coupling portion 32 in the X1-axis direction, the Y1-axis direction, and the Z1-axis direction.

Meanwhile, the fourth plug spring portion 34 has such an elastic force that displaces a position P5 of an end portion connected to the second coupling portion 35 with respect to a position P4 connected to the plug substrate connection portion 11 in the X1-axis direction, the Y1-axis direction, and the Z1-axis direction. The third plug spring portion 33 has such an elastic force that displaces a position P6 of an end portion connected to the second connection portion 38 with respect to the position P5 of the second coupling portion 35 in the X1-axis direction, the Y1-axis direction, and the Z1-axis direction. As a result, the plug contact portion 12 can move with respect to the plug substrate connection portion 11 in the X1-axis direction, the Y1-axis direction, and the Z1-axis direction by displacement of the positions P1, P2, and P3 and displacement of the positions P4, P5, and P6.

The plug contact connection portion 15 is divided into the first connection portion 37 and the second connection portion 38 by presence of the plug slit 36. Thus, the first connection portion 37 and the second connection portion 38 are each deformable independently. In this way, a greater relative movement of the plug contact portion 12 with respect to the plug substrate connection portion 11 in the X1-axis direction, the Y1-axis direction, and the Z1-axis direction can be achieved.

A portion in the position P2 of the second plug spring portion 31 can be relatively rotated about the X1-axis with respect to a portion in the position P1 by torsional deformation. A portion in the position P3 of the first plug spring portion 30 can be relatively rotated about the Y1-axis with respect to a portion in the position P2 by torsional deformation. A portion in the position P5 of the fourth plug spring portion 34 can be relatively rotated about the X1-axis with respect to a portion in the position P4 by torsional deformation. A portion in the position P6 of the third plug spring portion 33 can be relatively rotated about the Y1-axis with respect to a portion in the position P5 by torsional deformation. In this way, an inclination of the plug contact portion 12 with respect to the plug substrate connection portion 11 in the X1-axis direction and the Y1-axis direction can be achieved.

In addition, the plug contact portion 12 can be rotated about the Z1-axis with respect to the pair of the plug substrate connection portions 11 by elastic deformation of the first plug elastic portion 13 and the second plug elastic portion 14 and division of the plug contact connection portion 15 by the plug slit 36.

### [Receptacle Terminal]

Next, the receptacle terminal 2A is described. The receptacle terminal 2A is connected to the plug terminal 1 according to Embodiment 1.

As illustrated in FIGS. 6A and 6B, the receptacle terminal 2A is mounted on the second substrate 4. In FIGS. 6A and 6B, the second substrate 4 is indicated by a dotted line. In the present embodiment, the receptacle terminal 2A is described with reference to a three-axis orthogonal coordinate system including an X2-axis, a Y2-axis, and a Z2-axis. Herein, the X2-axis and the Y2-axis are defined as in-plane directions of a main surface of the second substrate 4. The Z2-axis is defined as a normal direction of the main surface of the second substrate 4.

The receptacle terminal 2A is connected to the plug terminal 1 (see FIGS. 1A and 1B) mounted on the first substrate 3 as described above, and is used for transmission of an electric signal or grounding between the first substrate 3 and the second substrate 4.

Similarly to the plug terminal 1, the receptacle terminal 2A is made of a conductive material. A material of the receptacle terminal 2A does not need to be the same material as the plug terminal 1, but the same material is preferably in terms of electrical conduction.

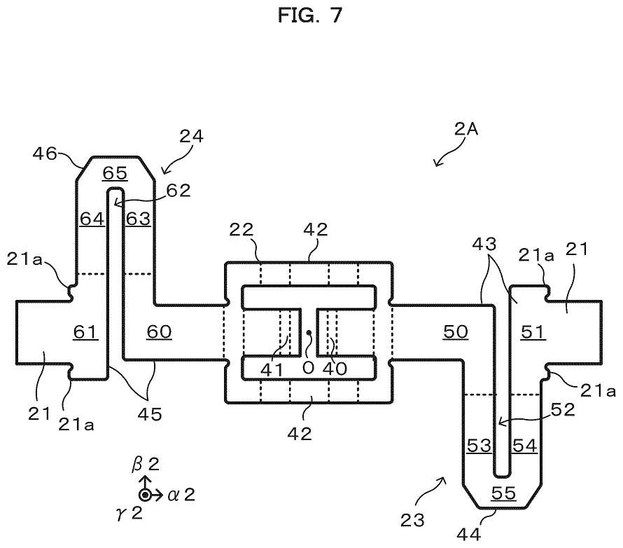

The receptacle terminal 2A is acquired by performing the punching and bending processing on a metal plate having elasticity. Specifically, the receptacle terminal 2A is processed into a shape illustrated in FIG. 7 by the punching processing on the metal plate having elasticity. In-plane directions of the metal plate are an α2-axis and a β2-axis, and a plate thickness of the metal plate is a γ2-axis. A shape of the metal plate is a point-symmetric shape with respect to a central point O. After the punching processing, the metal plate is bent at a portion of a broken line by the bending processing, and is processed into a shape illustrated in FIGS. 6A and 6B. The metal plate has a plate thickness of, for example, about 0.5 mm, which is not limited thereto.

Returning to FIGS. 6A and 6B, the receptacle terminal 2A includes a receptacle substrate connection portion 21, the receptacle contact portion 22, a first receptacle elastic portion 23, and a second receptacle elastic portion 24.

### [Receptacle Substrate Connection Portion]

The receptacle substrate connection portion 21 is connected to the second substrate 4. In the present embodiment, a pair of the receptacle substrate connection portions 21 is provided. The second substrate 4 has a rectangular through hole, and the receptacle substrate connection portion 21 is put into the through hole and is soldered. In this way, the receptacle substrate connection portion 21 is mounted on the main surface of the second substrate 4. A receptacle positioning portion 21a is provided around the receptacle substrate connection portion 21 in such a way as to prevent the receptacle substrate connection portion 21 from being mounted obliquely to the second substrate 4. An electronic part is mounted on the main surface of the second substrate 4, and an electric circuit including the electronic part is constructed. An electrode is connected to the electric circuit, and the receptacle substrate connection portion 21 put into the through hole is connected to the electrode.

### [Receptacle Contact Portion]

The receptacle contact portion 22 contacts the plug contact portion 12 (see FIGS. 1A and 1B) of the plug terminal 1 introduced and extracted in the introduction-extraction direction crossing the main surface of the second substrate 4. As illustrated in FIGS. 6A and 6B, the receptacle contact portion 22 is a recessed contact that protrudes in the +Z2 direction, and contacts the protruding plug contact portion 12 of the plug terminal 1 being put into the introduction-extraction direction.

The receptacle contact portion 22 includes a first contact 40 and a second contact 41 that contact the plug contact portion 12 of the plug terminal 1. As illustrated in FIGS. 6A, 6B, 7, 8A, 8B, and 9, the first contact 40 and the second contact 41 are disposed to face each other. As described below, the first contact 40 and the second contact 41 sandwich the plug contact portion 12 of the plug terminal 1 put between the first contact 40 and the second contact 41. In a facing surface of the sandwiching portion, the first contact 40 and the second contact 41 have driving contacts protruding in a direction close to each other. In this way, even when a position deviation occurs between the first contact 40 and the second contact 41, and the plug contact portion 12 of the plug terminal 1, the first contact 40 and the second contact 41 easily follow the plug contact portion 12.

The receptacle contact portion 22 includes a regulating portion 42 that regulates an increase in a gap between the first contact 40 and the second contact 41. As illustrated in FIG. 7, after the punching processing, the receptacle contact portion 22 has a shape of a rectangular frame as a whole, and the central point O is located at the center of the rectangular frame. The receptacle contact portion 22 has a point-symmetric shape with the central point O as the center. When viewed from the central point O, a band-shaped member protrudes from an inner side of the rectangular frame closer to +α2 to a position not exceeding the central point O in the −α2 direction. The band-shaped member is bent at a plurality of places including an end portion at a bent line parallel to the β2-axis direction, and the first contact 40 is acquired. When viewed from the central point O, a band-shaped member protrudes from an inner side of the rectangular frame closer to −α2 to a position not exceeding the central point O in the +α2 direction. The band-shaped member is bent at a plurality of places including an end portion at a bent line parallel to the 2-axis direction, and the second contact 41 is acquired.

A gap between the inner sides facing in the β2-axis direction is greater than a width in the α1-axis direction of the plug contact portion 12 of the plug terminal 1. The regulating portion 42 corresponds to the side on the +β2 side and the side on the −β2 side of the rectangular frame. The regulating portion 42 is acquired by being bent at two places at a bent line parallel to the β2-axis direction.

As illustrated in FIGS. 6A and 6B, the regulating portion 42 is bent in a recessed shape in a direction closer to the receptacle substrate connection portion 21, that is, the −Z2 direction with respect to the introduction-extraction direction. The reason is that the first contact 40 and the second contact 41 are brought closer to each other when the receptacle contact portion 22 is acquired by the bending processing on the metal plate (see FIG. 7). Further, by bending the regulating portion 42 in a recessed shape in the Z2 direction, the regulating portion 42 can be prevented from interfering with the plug contact portion 12 when the plug contact portion 12 of the plug terminal 1 is put between the first contact 40 and the second contact 41.

As illustrated in FIG. 7, in the receptacle contact portion 22, the first contact 40 is connected to the first receptacle elastic portion 23, and the second contact 41 is connected to the second receptacle elastic portion 24.

### [First Receptacle Elastic Portion]

The first receptacle elastic portion 23 connects one receptacle substrate connection portion 21 of the pair of the receptacle substrate connection portions 21 to the receptacle contact portion 22. As illustrated in FIG. 7, the first receptacle elastic portion 23 is a band-shaped member extending in the α2-axis direction and the β2-axis direction, includes one end in the +α2 direction and the +β2 direction connected to the receptacle substrate connection portion 21, and includes another end in the −α2 direction connected to the receptacle contact portion 22. The first receptacle elastic portion 23 has a receptacle slit 52 extending from the +β2 side toward the −β2 side in the β2-axis direction between the end portion connected to the receptacle contact portion 22 and the end portion connected to the receptacle substrate connection portion 21. The first receptacle elastic portion 23 has a bent shape due to the receptacle slit 52.

The first receptacle elastic portion 23 includes a first receptacle spring portion 43 and a second receptacle spring portion 44. As illustrated in FIG. 7, the first receptacle elastic portion 23 has a shape illustrated in FIGS. 6A and 6B and acquired by being bent at 90 degrees at a broken line parallel to the β2-axis with respect to the receptacle contact portion 22, and being bent at 90 degrees at a broken line parallel to the α2-axis at a boundary between the first receptacle spring portion 43 and the second receptacle spring portion 44.

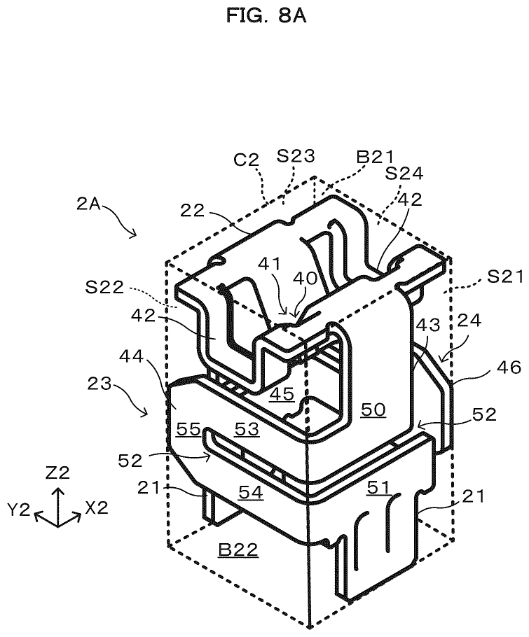

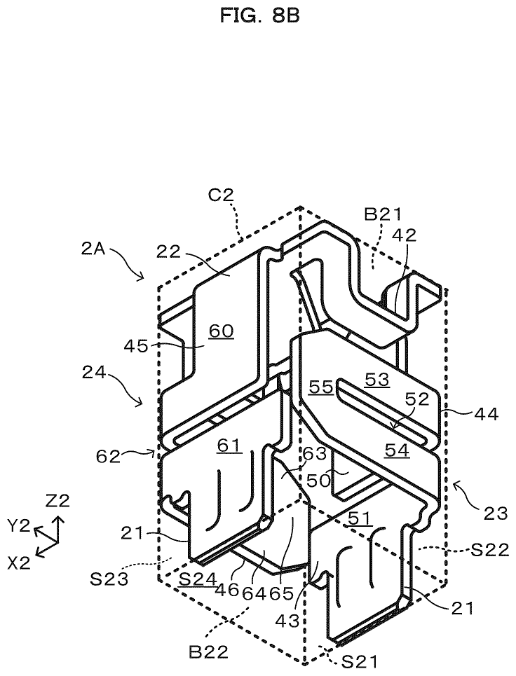

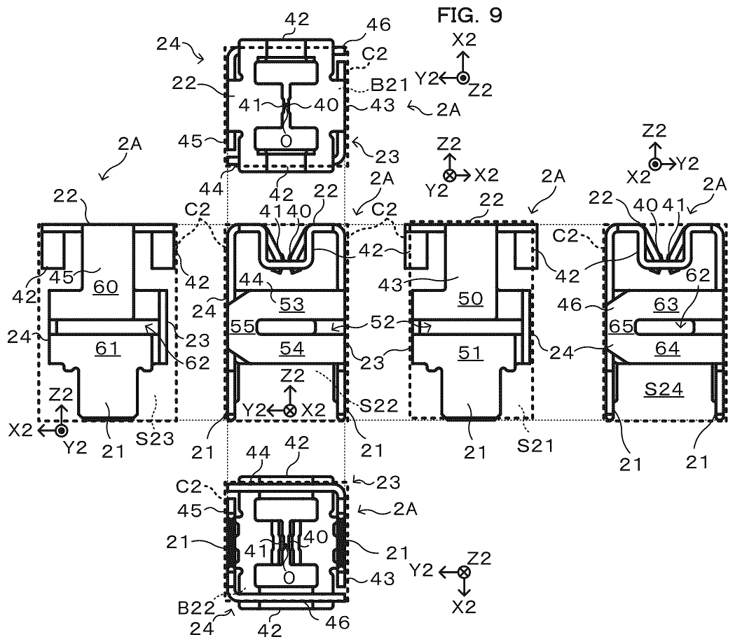

In the present embodiment, the first receptacle elastic portion 23 is bent with reference to a virtual second solid C2 illustrated in FIGS. 8A and 8B. The second solid C2 is a rectangular parallelepiped, that is, a quadrangular prism. The second solid C2 has, as a plane surface, a receptacle plane figure B21 containing the receptacle contact portion 22 when viewed from the introduction-extraction direction, and has a receptacle plane figure B22 as a bottom. The receptacle plane figures B21 and B22 have the Z2-axis direction as a normal direction. As illustrated in FIG. 9, the second solid C2 includes, as a part of side surfaces of the second solid C2, a first receptacle side surface S21, a second receptacle side surface S22, a third receptacle side surface S23, and a fourth receptacle side surface S24. The first receptacle side surface S21 and the third receptacle side surface S23 have the Y2-axis direction as a normal direction. The second receptacle side surface S22 and the fourth receptacle side surface S24 have the X2-axis direction as a normal direction. In this way, the first receptacle side surface S21 and the third receptacle side surface S23, and the second receptacle side surface S22 and the fourth receptacle side surface S24 have the different normal directions.

As illustrated in FIGS. 8A and 8B, the first receptacle spring portion 43 is provided along the first receptacle side surface S21 of the second solid C2. The first receptacle spring portion 43 has an elastic force, and is deformable with respect to the first receptacle side surface S21.

As illustrated in FIGS. 8A and 8B, the second receptacle spring portion 44 is provided along the second receptacle side surface S22 of the second solid C2. The second receptacle spring portion 44 has an elastic force, and is deformable with respect to the second receptacle side surface S22.

As illustrated in FIGS. 6A and 9, the first receptacle spring portion 43 is provided with a first receptacle contact connection portion 50 connected to the receptacle contact portion 22. The first receptacle contact connection portion 50 is a member having an L-shape (shape in which an L is viewed in a mirror plane) when viewed from a side closer to −Y2, and includes one end (+Z2 end) connected to the receptacle contact portion 22, extends from the portion in the −Z2 direction, and is bent in the −X2 direction.

The first receptacle spring portion 43 and the second receptacle spring portion 44 have the receptacle slit 52 extending in a direction crossing the introduction-extraction direction. As illustrated in FIG. 9, the first receptacle spring portion 43 is divided into the above-described first receptacle contact connection portion 50 and a third extension portion 51 by the receptacle slit 52. The second receptacle spring portion 44 includes a first extension portion 53, a second extension portion 54, and a first return portion 55 due to the receptacle slit 52.

As illustrated in FIG. 9, the first extension portion 53 extends in the Y2-axis direction being the direction crossing the introduction-extraction direction. The first extension portion 53 includes one end (−Y2 end) connected to an end portion of the first receptacle contact connection portion 50 on a side closer to −X2. The second extension portion 54 is disposed closer to the receptacle substrate connection portion 21 than the first extension portion 53. The second extension portion 54 extends in parallel with the first extension portion 53, that is, in the Y2-axis direction. The first return portion 55 couples another end (+Y2 end) of the first extension portion 53 to one end (+Y2 end) of the second extension portion 54 facing the other end in the introduction-extraction direction, that is, the Z2-axis direction.

Furthermore, in the first receptacle spring portion 43, the third extension portion 51 is located closer to the receptacle substrate connection portion 21 than the first receptacle contact connection portion 50, and extends in the X2-axis direction crossing the introduction-extraction direction. One end (−X2 end) of the third extension portion 51 is connected to another end (−Y2 end) of the second extension portion 54. The third extension portion 51 is connected to the receptacle substrate connection portion 21.

As described above, the first receptacle elastic portion 23 starts from the receptacle contact portion 22, includes the first receptacle contact connection portion 50, the first extension portion 53, the first return portion 55, the second extension portion 54, and the third extension portion 51 that are coupled in this order, and is connected to the receptacle substrate connection portion 21 in the end.

### [Second Receptacle Elastic Portion]

The second receptacle elastic portion 24 connects the other receptacle substrate connection portion 21 not being connected to the first receptacle elastic portion 23 of the pair of the receptacle substrate connection portions 21 to the receptacle contact portion 22. As illustrated in FIG. 7, the second receptacle elastic portion 24 is a band-shaped member extending in the α2-axis direction and the β2-axis direction, includes one end in the −α2 direction and the −β2 direction connected to the receptacle substrate connection portion 21, and includes another end in the +α2 direction connected to the receptacle contact portion 22. The second receptacle elastic portion 24 has a receptacle slit 62 extending from the −β2 side toward the +β2 side in the β2-axis direction between the end portion connected to the receptacle contact portion 22 and the end portion connected to the receptacle substrate connection portion 21. The second receptacle elastic portion 24 has a bent shape due to the receptacle slit 62.

The second receptacle elastic portion 24 includes a third receptacle spring portion 45 and a fourth receptacle spring portion 46. As illustrated in FIG. 7, the second receptacle elastic portion 24 has a shape illustrated in FIGS. 6A and 6B and acquired by being bent at 90 degrees at a broken line parallel to the β2-axis with respect to the receptacle contact portion 22, and being bent at 90 degrees at a broken line parallel to the α2-axis at a boundary between the third receptacle spring portion 45 and the fourth receptacle spring portion 46. The second receptacle elastic portion 24 is bent with reference to the virtual second solid C2 illustrated in FIGS. 8A and 8B.

As illustrated in FIGS. 8A and 8B, the third receptacle spring portion 45 is provided along the third receptacle side surface S23 of the second solid C2. The third receptacle spring portion 45 has an elastic force, and is deformable with respect to the third receptacle side surface S23.

As illustrated in FIG. 9, the fourth receptacle spring portion 46 is provided along the fourth receptacle side surface S24 of the second solid C2. The fourth receptacle spring portion 46 has an elastic force, and is deformable with respect to the fourth receptacle side surface S24.

As illustrated in FIGS. 6B and 9, the third receptacle spring portion 45 is provided with a second receptacle contact connection portion 60 connected to the receptacle contact portion 22. The second receptacle contact connection portion 60 is a member having an L-shape (shape in which an L is viewed in a mirror plane) when viewed from a side closer to +Y2, and includes one end (+Z2 end) connected to the receptacle contact portion 22, extends from the portion in the −Z2 direction, and is bent in the +X2 direction.

The third receptacle spring portion 45 and the fourth receptacle spring portion 46 have the receptacle slit 62 extending in the direction crossing the introduction-extraction direction. As illustrated in FIG. 9, the third receptacle spring portion 45 is divided into the above-described second receptacle contact connection portion 60 and a seventh extension portion 61 by the receptacle slit 62. The fourth receptacle spring portion 46 includes a fifth extension portion 63, a sixth extension portion 64, and a third return portion 65 due to the receptacle slit 62.

As illustrated in FIG. 9, the fifth extension portion 63 extends in the Y2-axis direction being the direction crossing the introduction-extraction direction. The fifth extension portion 63 includes one end (+Y2 end) connected to an end portion of the second receptacle contact connection portion 60 on a side closer to +X2. The sixth extension portion 64 is disposed closer to the receptacle substrate connection portion 21 than the fifth extension portion 63. The sixth extension portion 64 extends in parallel with the fifth extension portion 63, that is, in the Y2-axis direction. The third return portion 65 couples another end (−Y2 end) of the fifth extension portion 63 to one end (−Y2 end) of the sixth extension portion 64 facing the other end in the introduction-extraction direction, that is, the Z2-axis direction.

Furthermore, in the third receptacle spring portion 45, the seventh extension portion 61 is located closer to the receptacle substrate connection portion 21 than the second receptacle contact connection portion 60, and extends in the X2-axis direction crossing the introduction-extraction direction. One end (+X2 end) of the seventh extension portion 61 is connected to another end (+Y2 end) of the sixth extension portion 64. The seventh extension portion 61 is connected to the receptacle substrate connection portion 21.

As described above, the second receptacle elastic portion 24 starts from the receptacle contact portion 22, includes the second receptacle contact connection portion 60, the fifth extension portion 63, the third return portion 65, the sixth extension portion 64, and the seventh extension portion 61 that are coupled in this order, and is connected to the receptacle substrate connection portion 21.

As illustrated in FIG. 9, the first receptacle elastic portion 23 and the second receptacle elastic portion 24 are disposed in a point symmetry with the receptacle contact portion 22 as the center when viewed from the introduction-extraction direction (Z2-axis direction).

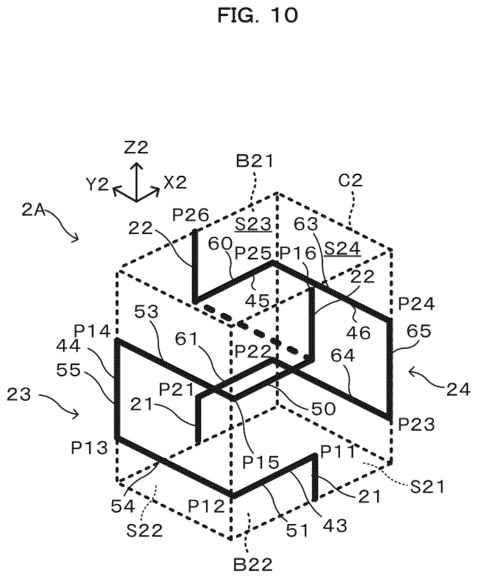

FIG. 10 illustrates a schematic view of a simplified structure of the first receptacle elastic portion 23 and the second receptacle elastic portion 24. FIG. 10 illustrates, as a linear member, the first receptacle spring portion 43 and the second receptacle spring portion 44 constituting the first receptacle elastic portion 23. FIG. 10 illustrates, as a linear member, the third receptacle spring portion 45 and the fourth receptacle spring portion 46 constituting the second receptacle elastic portion 24. The same applies to the receptacle substrate connection portion 21 and the receptacle contact portion 22.

A position of the receptacle substrate connection portion 21 connected to the second substrate 4 is fixed. However, the first receptacle elastic portion 23 and the second receptacle elastic portion 24 that connect the receptacle substrate connection portion 21 and the receptacle contact portion 22 have an elastic force, and are thus deformable by a force received from the receptacle contact portion 22.

More specifically, as illustrated in FIG. 10, in the first receptacle elastic portion 23, the third extension portion 51 can displace a position P12 of an end portion connected to the second extension portion 54 with respect to a position P11 connected to the receptacle substrate connection portion 21 in the X2-axis direction, the Y2-axis direction, and the Z2-axis direction, and can twist and rotate the position P12 about the X2-axis. The second extension portion 54 can displace a position P13 of an end portion connected to the first return portion 55 with respect to the position P12 in the X2-axis direction, the Y2-axis direction, and the Z2-axis direction, and can twist and rotate the position P13 about the Y2-axis. The first return portion 55 can displace a position P14 of an end portion connected to the first extension portion 53 with respect to the position P13 in the X2-axis direction, the Y2-axis direction, and the Z2-axis direction, and can twist and rotate the position P14 about the Z2-axis. The first extension portion 53 can displace a position P15 of an end portion connected to the first receptacle contact connection portion 50 with respect to the position P14, and can twist and rotate the position P15 about the Y2-axis. The first receptacle contact connection portion 50 can displace a position P16 of an end portion connected to the receptacle connection portion 22 with respect to the position P15, and can twist and rotate the position P16 about the X2-axis and the Z2-axis.

As illustrated in FIG. 10, the second receptacle elastic portion 24 can achieve displacement in the X2-axis, the Y2-axis, and the Z2-axis of positions P21, P22, P23, P24, P25, and P26 and rotation about the axis in the extending direction between the receptacle substrate connection portion 21 and the receptacle contact portion 22 with reference to the receptacle substrate connection portion 21 having a fixed position. In this way, the receptacle contact portion 22 can move in the X2-axis direction, the Y2-axis direction, and the Z2-axis direction and can rotate in a rotational direction about each axis by displacement of the positions P11 to P16 and displacement of the positions P21 to P26.

In other words, the first receptacle elastic portion 23 and the second receptacle elastic portion 24 can be greatly displaced in the X2-axis direction, the Y2-axis direction, the Z2-axis direction, and the rotational direction about each axis due to the receptacle slits 52 and 62.

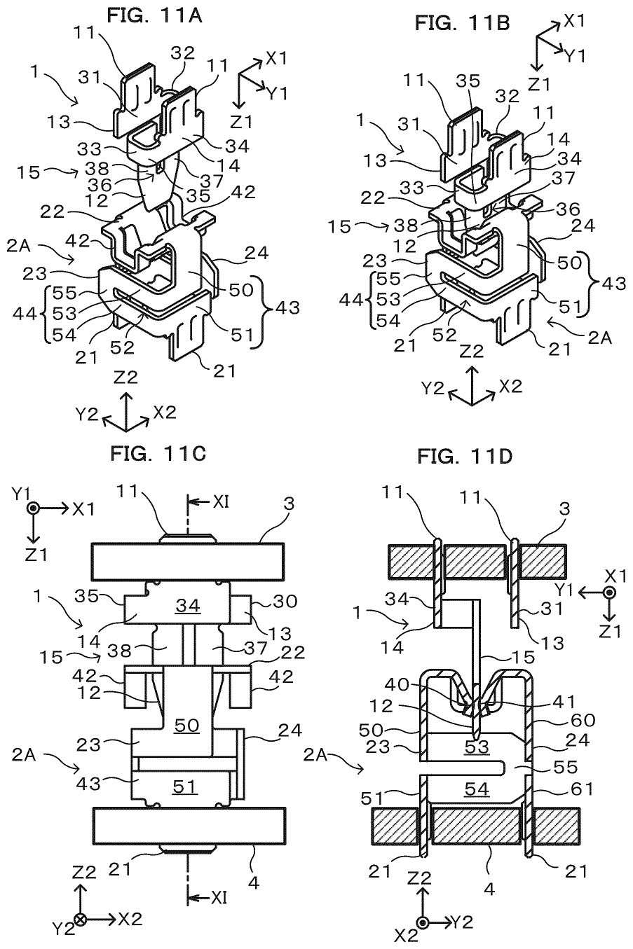

Next, a fitting operation of the plug terminal 1 and the receptacle terminal 2A according to Embodiment 1 is described. When the plug terminal 1 and the receptacle terminal 2A are fitted, as illustrated in FIG. 11A, the plug terminal 1 and the receptacle terminal 2A are disposed in such orientations that the +Z1 direction and the +Z2 direction are opposite directions.

Then, as illustrated in FIGS. 11B, 11C, and 11D, the protruding plug contact portion 12 of the plug terminal 1 is put into the recessed receptacle contact portion 22 of the receptacle terminal 2A, and thus the plug terminal 1 and the receptacle terminal 2A are connected to each other. In this way, an electric circuit of the first substrate 3 and an electric circuit of the second substrate 4 are electrically connected with each other via the plug terminal 1 and the receptacle terminal 2A, and transmission of a signal or grounding between the first substrate 3 and the second substrate 4 can be achieved.

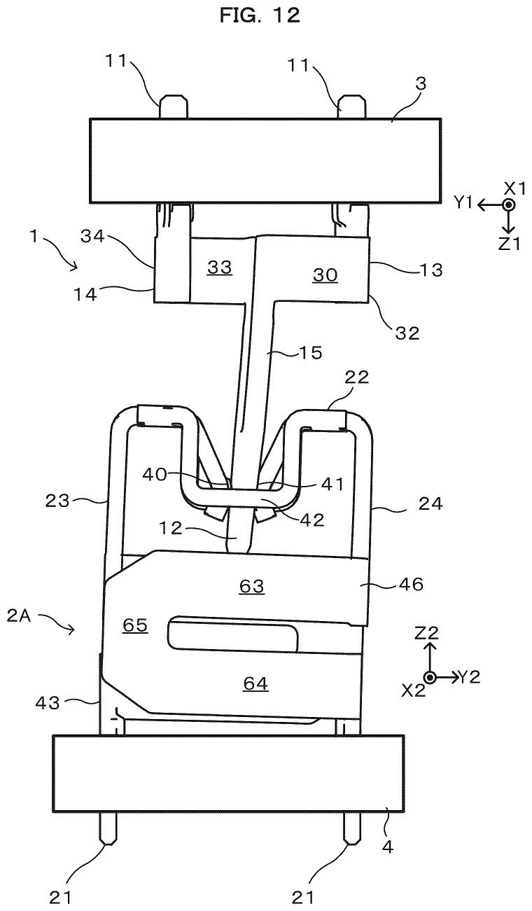

FIG. 12 illustrates a scene where the plug terminal 1 and the receptacle terminal 2A are fitted. In the example illustrated in FIG. 12, the plug contact portion 12 of the plug terminal 1 deviates in the +Y1 direction (−Y2 direction) from and is put into the receptacle contact portion 22 of the receptacle terminal 2A. Thus, the first plug spring portion 30 and the second plug spring portion 31 of the plug terminal 1 and the third plug spring portion 33 and the fourth plug spring portion 34 of the plug terminal 1 are deformed and absorb the deviation.

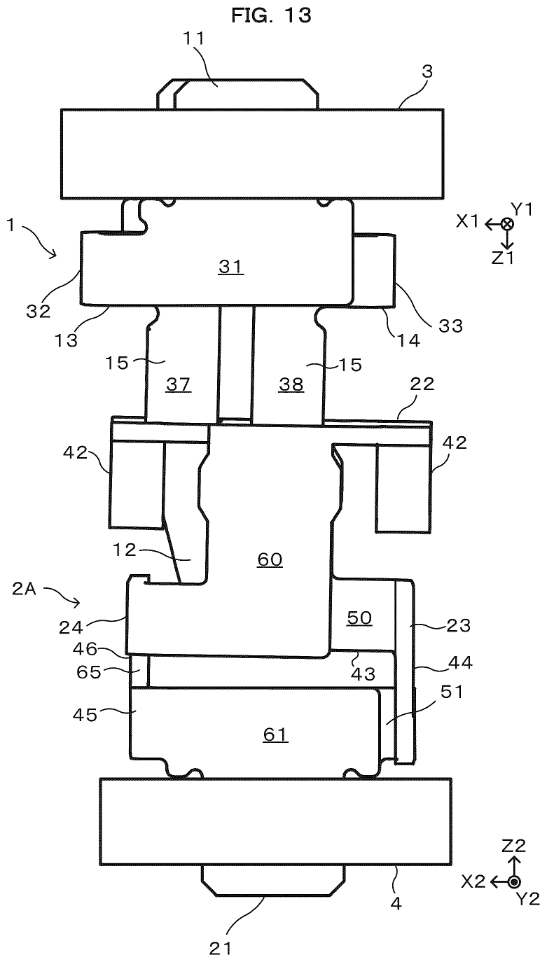

FIG. 13 illustrates a scene where the plug terminal 1 and the receptacle terminal 2A are fitted. In the example illustrated in FIG. 13, the plug contact portion 12 of the plug terminal 1 deviates in the +X1 direction (+X2 direction) from and is put into the receptacle contact portion 22 of the receptacle terminal 2A. Thus, the first plug spring portion 30 and the second plug spring portion 31 of the plug terminal 1 and the third plug spring portion 33 and the fourth plug spring portion 34 of the plug terminal 1 are deformed and absorb the deviation.

In this way, even when there is a deviation between a position of the plug contact portion 12 of the plug terminal 1 and a position of the receptacle contact portion 22 of the receptacle terminal 2A, a difference in the deviation is absorbed by the first plug spring portion 30 and the second plug spring portion 31 of the plug terminal 1, and the third plug spring portion 33 and the fourth plug spring portion 34 of the plug terminal 1, and an excellent connection between the plug terminal 1 and the receptacle terminal 2A can be achieved.

Note that a size in the X1-axis direction of the plug terminal 1 can be, for example, 9 mm, a size in the Y1-axis direction can be, for example, 6 mm, and the entire height in the Z1-axis direction can be about 23 mm, which are not limited thereto. Further, a size in the X2-axis direction of the receptacle terminal 2A can be, for example, 9 mm, a size in the Y2-axis direction can be, for example, 8 mm, and the entire height in the Z2-axis direction can be about 9 mm, which are not limited thereto.

### Embodiment 2

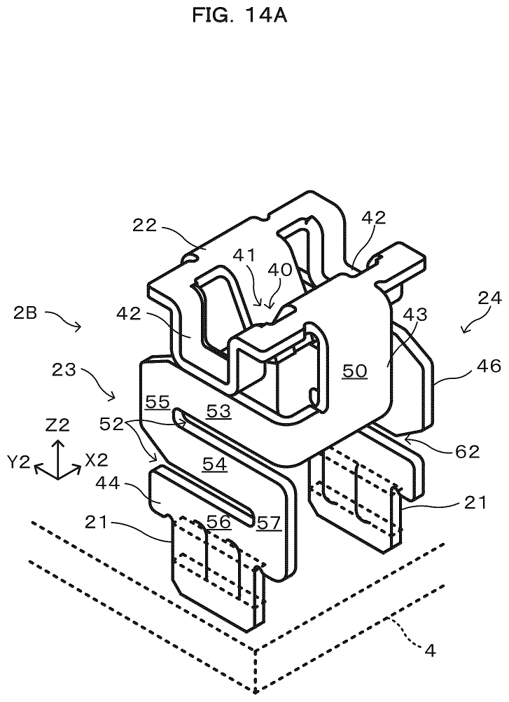

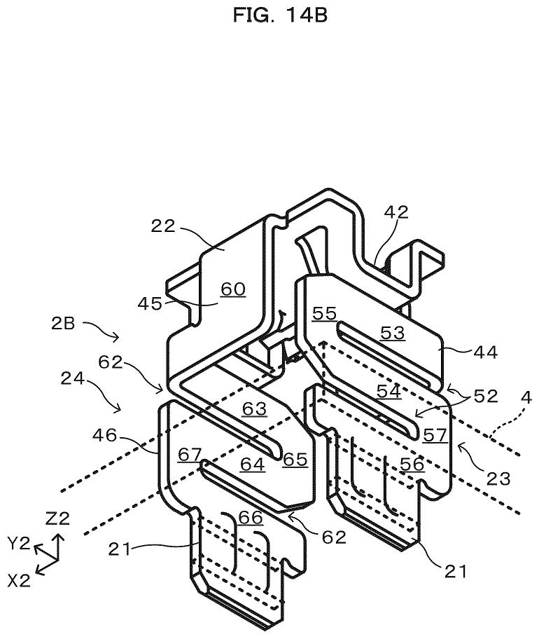

Embodiment 2 of the present disclosure is described. In Embodiment 2, a plug terminal 1 is the same as that in Embodiment 1 described above. In Embodiment 2, a receptacle terminal 2B illustrated in FIGS. 14A and 14B is used instead of the receptacle terminal 2A.

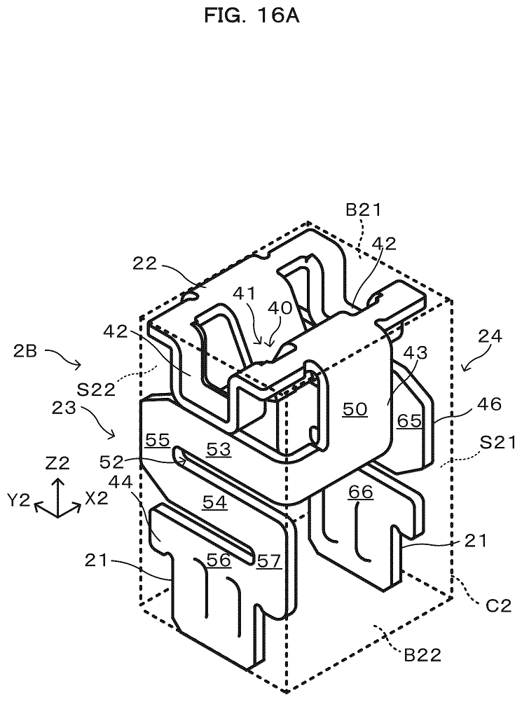

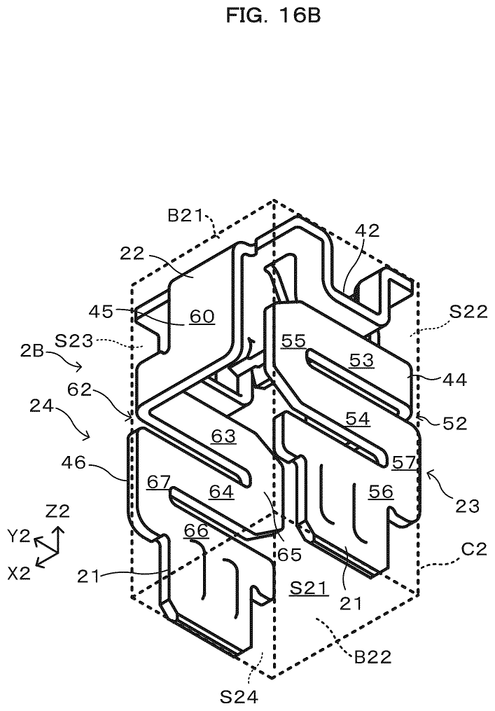

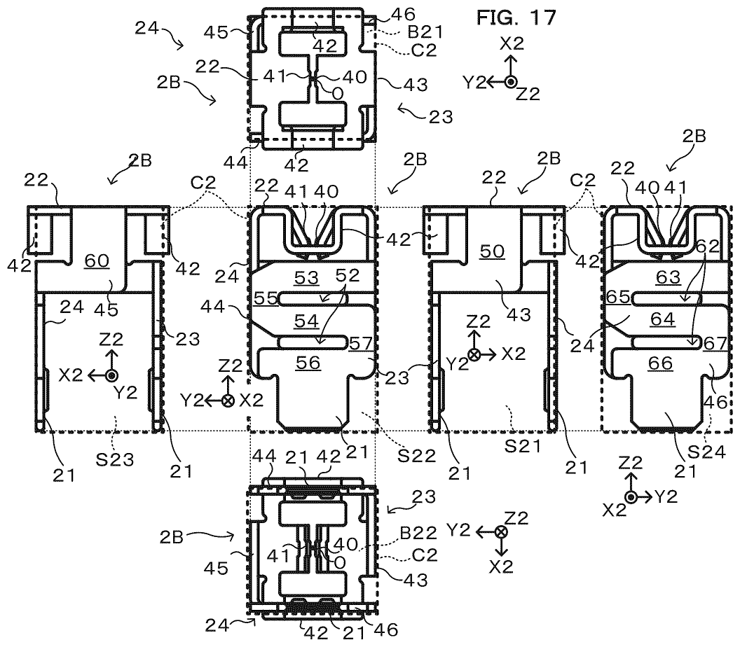

As illustrated in FIGS. 14A and 14B, the receptacle terminal 2B is the same as the receptacle terminal 2A in a point of including a receptacle substrate connection portion 21, a receptacle contact portion 22, a first receptacle elastic portion 23, and a second receptacle elastic portion 24. The receptacle terminal 2B is also the same as the receptacle terminal 2A in a point that the first receptacle elastic portion 23 includes a first receptacle spring portion 43 and a second receptacle spring portion 44 and the second receptacle elastic portion 24 includes a third receptacle spring portion 45 and a fourth receptacle spring portion 46. As illustrated in FIGS. 16A, 16B, and 17, the receptacle terminal 2B is also the same as the receptacle terminal 2A in a point that the first receptacle spring portion 43 is provided along a first receptacle side surface S21 of a second solid C2, a point that the second receptacle spring portion 44 is provided along a second receptacle side surface S22 of the second solid C2, a point that the third receptacle spring portion 45 is provided along a third receptacle side surface S23 of the second solid C2, and a point that the fourth receptacle spring portion 46 is provided along a fourth receptacle side surface S24 of the second solid C2.

The receptacle terminal 2B is different from the receptacle terminal 2A in a configuration of the first receptacle spring portion 43, the second receptacle spring portion 44, the third receptacle spring portion 45, and the fourth receptacle spring portion 46.

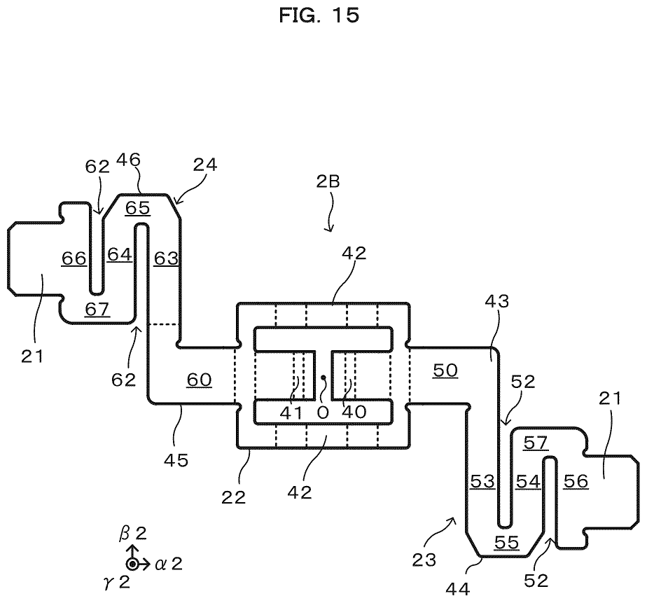

A material of the receptacle terminal 2B is the same as that of the receptacle terminal 2A. The receptacle terminal 2B is acquired by processing a metal plate having elasticity into a shape illustrated in FIG. 15 by the punching processing, then bending the metal plate at a portion of a broken line by the bending processing, and processing the metal plate into a shape along the first receptacle side surface S21 to the fourth receptacle side surface S24 of the second solid C2 illustrated in FIGS. 16A and 16B. The metal plate illustrated in FIG. 15 has a configuration slightly different from the metal plate illustrated in FIG. 7. Specifically, in the metal plate illustrated in FIG. 15, a fourth extension portion 56 and a second return portion 57 are provided instead of the third extension portion 51, and an eighth extension portion 66 and a fourth return portion 67 are provided instead of the seventh extension portion 61. In the metal plate illustrated in FIG. 15, a receptacle slit 52 in an opposite direction to the receptacle slit 52 provided between a first extension portion 53 and a second extension portion 54 is provided between the second extension portion 54 and the fourth extension portion 56, and the fourth extension portion 56 and the second return portion 57 are provided due to the receptacle slit 52. Further, a receptacle slit 62 in an opposite direction to the receptacle slit 62 provided between a fifth extension portion 63 and a sixth extension portion 64 is provided between the sixth extension portion 64 and the eighth extension portion 66, and the eighth extension portion 66 and the fourth return portion 67 are provided due to the receptacle slit 62.

In this way, in the receptacle terminal 2B, the second receptacle spring portion 44 includes the fourth extension portion 56 and the second return portion 57. As illustrated in FIGS. 16A and 17, the fourth extension portion 56 is disposed closer to the receptacle substrate connection portion 21 than the second extension portion 54. The fourth extension portion 56 extends in the Y2-axis direction in parallel with the second extension portion 54, and is connected to the receptacle substrate connection portion 21. The second return portion 57 couples another end (−Y2 end) of the second extension portion 54 to one end (−Y2 end) of the fourth extension portion 56 facing the other end in the introduction-extraction direction (Z2-axis direction).

In the receptacle terminal 2B, the fourth receptacle spring portion 46 includes the eighth extension portion 66 and the fourth return portion 67. As illustrated in FIGS. 16B and 17, the eighth extension portion 66 is disposed closer to the receptacle substrate connection portion 21 than the sixth extension portion 64. The eighth extension portion 66 extends in the Y2-axis direction in parallel with the sixth extension portion 64, and is connected to the receptacle substrate connection portion 21. The fourth return portion 67 couples another end (+Y2 end) of the sixth extension portion 64 to one end (+Y2 end) of the eighth extension portion 66 facing the other end in the introduction-extraction direction (Z2-axis direction).

Also, in the receptacle terminal 2B, the first receptacle spring portion 43, the second receptacle spring portion 44, the third receptacle spring portion 45, and the fourth receptacle spring portion 46 can displace the receptacle contact portion 22 in the X2-axis direction, the Y2-axis direction, the Z2-axis direction, and the rotational direction of each axis with respect to the receptacle substrate connection portion 21. Since the number of the receptacle slits 52 and 62 is greater in the receptacle terminal 2B than the receptacle terminal 2A, a displacement amount in the X2-axis direction, the Y2-axis direction, the Z2-axis direction, and the rotational direction of each axis can be increased.

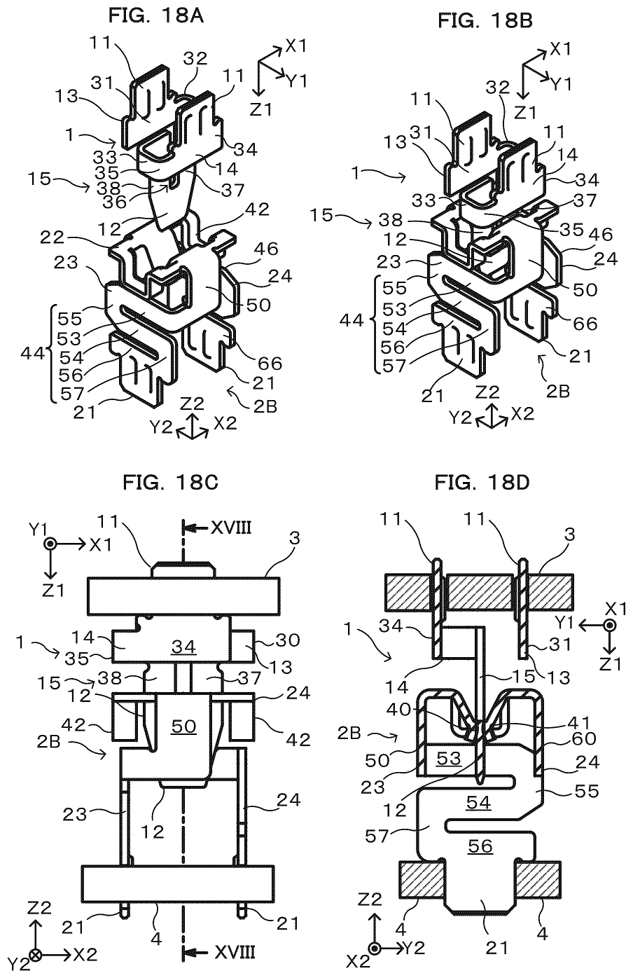

Next, a fitting operation of the plug terminal 1 and the receptacle terminal 2B according to Embodiment 2 is described. When the plug terminal 1 and the receptacle terminal 2B are fitted, as illustrated in FIG. 18A, the plug terminal 1 and the receptacle terminal 2B are disposed in such orientations that the +Z1 direction and the +Z2 direction are opposite directions.

Then, as illustrated in FIGS. 18B, 18C, and 18D, a protruding plug contact portion 12 of the plug terminal 1 is put into the recessed receptacle contact portion 22 of the receptacle terminal 2B, and thus the plug terminal 1 and the receptacle terminal 2B are connected to each other. In this way, an electric circuit of a first substrate 3 and an electric circuit of a second substrate 4 are electrically connected with each other via the plug terminal 1 and the receptacle terminal 2B, and transmission of a signal or grounding between the first substrate 3 and the second substrate 4 can be achieved.

### Embodiment 3

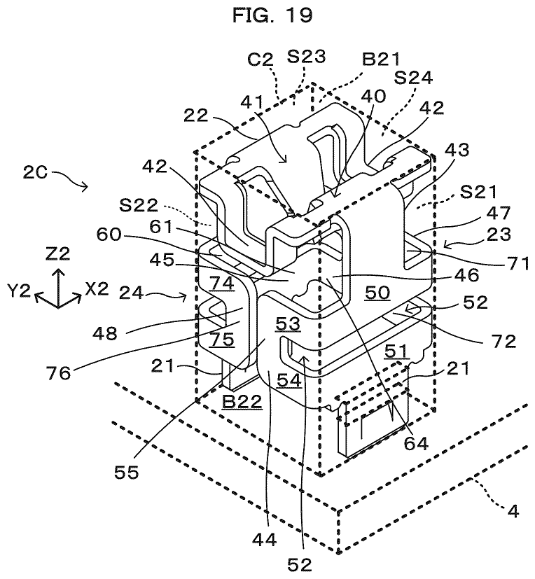

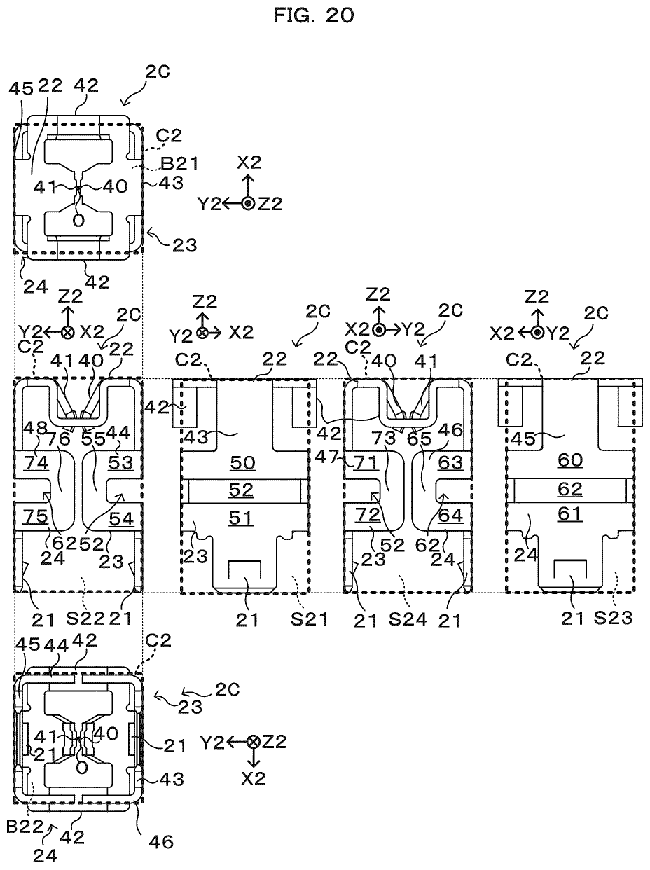

Embodiment 3 of the present disclosure is described. In Embodiment 3, a plug terminal 1 is the same as that in Embodiment 1 described above. In Embodiment 3, a receptacle terminal 2C illustrated in FIGS. 19 and 20 is used instead of the receptacle terminal 2A.

As illustrated in FIGS. 19 and 20, the receptacle terminal 2C is the same as the receptacle terminal 2A in a point of including a receptacle substrate connection portion 21, a receptacle contact portion 22, a first receptacle elastic portion 23, and a second receptacle elastic portion 24. The receptacle terminal 2C is also the same as the receptacle terminal 2A in a point that the first receptacle elastic portion 23 includes a first receptacle spring portion 43 and a second receptacle spring portion 44 and the second receptacle elastic portion 24 includes a third receptacle spring portion 45 and a fourth receptacle spring portion 46. The receptacle terminal 2C is also the same as the receptacle terminal 2A in a point that the first receptacle spring portion 43 is provided along a first receptacle side surface S21 of a second solid C2, a point that the second receptacle spring portion 44 is provided along a second receptacle side surface S22 of the second solid C2, a point that the third receptacle spring portion 45 is provided along a third receptacle side surface S23 of the second solid C2, and a point that the fourth receptacle spring portion 46 is provided along a fourth receptacle side surface S24 of the second solid C2.

Also, in the present embodiment, the first receptacle spring portion 43 and the second receptacle spring portion 44 have a receptacle slit 52 being a slit extending in the direction crossing the introduction-extraction direction. Further, the first receptacle spring portion 43 is divided into a first receptacle contact connection portion 50 and a third extension portion 51 by the receptacle slit 52. The second receptacle spring portion 44 includes a first extension portion 53, a second extension portion 54, and a first return portion 55 due to the receptacle slit 52. However, in the present embodiment, a length in the Y2-axis direction of the first extension portion 53 and the second extension portion 54 is less than half a width in the Y2-axis direction of the receptacle terminal 2C.

The third receptacle spring portion 45 and the fourth receptacle spring portion 46 have a receptacle slit 62 extending in the direction crossing the introduction-extraction direction. The third receptacle spring portion 45 is divided into a second receptacle contact connection portion 60 and a seventh extension portion 61 by the receptacle slit 62. The fourth receptacle spring portion 46 includes a fifth extension portion 63, a sixth extension portion 64, and a third return portion 65 due to the receptacle slit 62. However, in the present embodiment, a length in the Y2-axis direction of the fifth extension portion 63 and the sixth extension portion 64 is less than half a width in the Y2-axis direction of the receptacle terminal 2C.

In the present embodiment, the first receptacle elastic portion 23 includes a fifth receptacle spring portion 47 in addition to the first receptacle spring portion 43 and the second receptacle spring portion 44. The second receptacle elastic portion 24 includes a sixth receptacle spring portion 48 in addition to the third receptacle spring portion 45 and the fourth receptacle spring portion 46.

The fifth receptacle spring portion 47 is provided along the fourth receptacle side surface S24 that is a part of the side surfaces of the second solid C2 and faces the second receptacle side surface S22. The fifth receptacle spring portion 47 is deformable with respect to the fourth receptacle side surface S24. The fifth receptacle spring portion 47 has the receptacle slit 52 being a slit extending in the direction crossing the introduction-extraction direction. The fifth receptacle spring portion 47 includes, due to the receptacle slit 52, a ninth extension portion 71 extending in the direction crossing the introduction-extraction direction and including one end connected to the first receptacle contact connection portion 50, a tenth extension portion 72 being disposed closer to the receptacle substrate connection portion 21 than the ninth extension portion 71 and extending in parallel with the ninth extension portion 71, and a fifth return portion 73 coupling, in the introduction-extraction direction, another end of the ninth extension portion 71 to one end of the tenth extension portion 72 facing the other end. Another end of the third extension portion 51 is connected to another end of the tenth extension portion 72. A shape and a size of a member acquired by coupling the ninth extension portion 71, the tenth extension portion 72, and the fifth return portion 73 are the same as a shape and a size of a member acquired by coupling the first extension portion 53, the second extension portion 54, and the first return portion 55.

The sixth receptacle spring portion 48 is provided along the second receptacle side surface S22 being a part of the side surfaces of the second solid C2. The sixth receptacle spring portion 48 is deformable with respect to the second receptacle side surface S22. The sixth receptacle spring portion 48 has the receptacle slit 62 being a slit extending in the direction crossing the introduction-extraction direction. The sixth receptacle spring portion 48 includes, due to the receptacle slit 62, an eleventh extension portion 74 extending in the direction crossing the introduction-extraction direction and including one end connected to the second receptacle contact connection portion 60, a twelfth extension portion 75 being disposed closer to the receptacle substrate connection portion 21 than the eleventh extension portion 74 and extending in parallel with the eleventh extension portion 74, and a sixth return portion 76 coupling, in the introduction-extraction direction, another end of the eleventh extension portion 74 to one end of the twelfth extension portion 75 facing the other end. Another end of the seventh extension portion 61 is connected to another end of the twelfth extension portion 75. A shape and a size of a member acquired by coupling the eleventh extension portion 74, the twelfth extension portion 75, and the sixth return portion 76 are the same as a shape and a size of a member acquired by coupling the fifth extension portion 63, the sixth extension portion 64, and the third return portion 65.

The receptacle terminal 2C according to the present embodiment has a shape having a line symmetry with reference to an axis parallel to the X2-axis through a central point O and having a line symmetry with reference to an axis parallel to the Y2-axis through the central point O. With such a shape, deformation of a terminal can be made equal when force is applied in the +X direction and when force is applied in the −X direction, and deformation of the terminal can also be made equal when force is applied in the +Y direction and when force is applied in the −Y direction.

### [Effect of Plug Terminal]

As described above in detail, in the plug terminal 1 according to the present embodiment, the first plug elastic portion 13 that connects the plug substrate connection portion 11 and the plug contact portion 12 includes the first plug spring portion 30 that is deformable with respect to the first plug side surface S11 being a part of the side surfaces of the virtual first solid C1 having, as a plane surface, the plug plane figure B11 containing the plug contact portion 12, and the second plug spring portion 31 that is deformable with respect to the second plug side surface S12. In this way, a relative position of the plug contact portion 12 with respect to the plug substrate connection portion 11 can deviate in the X1-axis direction and the Y1-axis direction crossing the introduction-extraction direction of the receptacle tenminals 2A, 2B, and 2C. Further, a relative position of the plug contact portion 12 with respect to the plug substrate connection portion 11 can deviate in the Z1-axis direction parallel to the introduction-extraction direction. Furthermore, a rotational position of the plug contact portion 12 with respect to the plug substrate connection portion 11 can deviate in the rotational direction of each axis. Thus, followability with respect to the receptacle terminals 2A, 2B, and 2C can be improved.

Further, in the plug terminal 1, the second plug elastic portion 14 that connects the plug substrate connection portion 11 and the plug contact portion 12 includes the third plug spring portion 33 that is deformable with respect to the third plug side surface S13 being a part of the side surfaces of the virtual first solid C1 having, as a plane surface, the plug plane figure B11 containing the plug contact portion 12 or having the plug plane figure B12 as a bottom when viewed from the introduction-extraction direction of the receptacle terminals 2A, 2B, and 2C as the other terminal, and the fourth plug spring portion 34 that is deformable with respect to the fourth plug side surface S14. In this way, a relative position of the plug contact portion 12 with respect to the plug substrate connection portion 11 can deviate in the X1-axis direction and the Y1-axis direction crossing the introduction-extraction direction of the receptacle terminals 2A, 2B, and 2C, the Z1-axis direction parallel to the introduction-extraction direction, and the rotational direction of each axis. Thus, followability with respect to the receptacle terminals 2A, 2B, and 2C can be improved.

Note that a displacement amount (floating amount) in the X1-axis direction, a displacement amount in the Y1-axis direction, and a displacement amount in the Z1-axis direction may be different. For example, a maximum displacement amount in the X1-axis direction and a maximum displacement amount in the Y-axis direction may be different, or a displacement amount in the Z1-axis direction may be smaller than a displacement amount in the X1-axis direction and a displacement amount in the Y1-axis direction.

With the plug terminal 1, the first plug elastic portion 13 and the second plug elastic portion 14 are bent in the X1-axis direction and the Y1-axis direction, and thus a displacement amount of the plug contact portion 12 with respect to the plug substrate connection portion 11 can be increased regardless of a small size. Conversely, the entire plug terminal 1 can be reduced in size while a displacement amount of the plug contact portion 12 with respect to the plug substrate connection portion 11 is maintained.

In the plug terminal 1, the plug contact connection portion 15 that connects the plug contact portion 12 to the first plug elastic portion 13 and the second plug elastic portion 14 has the plug slit 36. In this way, a displacement of the plug contact portion 12 with respect to the plug substrate connection portion 11 can be further increased. Further, stress generated by deformation of the first plug elastic portion 13 and the second plug elastic portion 14 can be reduced.

In the plug terminal 1, the first plug elastic portion 13 and the second plug elastic portion 14 are disposed in a point symmetry with the plug contact portion 12 as the center when viewed from the introduction-extraction direction. In this way, a displacement amount of the plug contact portion 12 can be set the same in the positive direction and the negative direction of each axis. Further, even when the plug contact portion 12 deviates from the plug substrate connection portion 11, and the first plug elastic portion 13 and the second plug elastic portion 14 are deformed, stress on both of the first plug elastic portion 13 and the second plug elastic portion 14 can be made equal.

The plug terminal 1 has an S-shape when viewed from the introduction-extraction direction. In such a manner, even when the plug contact portion 12 deviates from the plug substrate connection portion 11 in the rotational direction about the Z1-axis, the first plug elastic portion 13 and the second plug elastic portion 14 are deformed in the same manner, and stress on both of the first plug elastic portion 13 and the second plug elastic portion 14 can be made equal.

### [Effect of Receptacle Terminal]

In the receptacle terminals 2A, 2B, and 2C according to the present embodiment, the first receptacle elastic portion 23 that connects the receptacle substrate connection portion 21 and the receptacle contact portion 22 includes the first receptacle spring portion 43 that is deformable with respect to the first receptacle side surface S21 being a part of the side surfaces of the virtual second solid C2 having the receptacle plane figure B21 as a plane surface or having the receptacle plane figure B22 as a bottom, and the second receptacle spring portion 44 that is deformable with respect to the second receptacle side surface S22. In this way, a relative position of the receptacle contact portion 22 with respect to the receptacle substrate connection portion 21 can deviate in the X2-axis direction and the Y2-axis direction crossing the introduction-extraction direction of the receptacle terminals 2A, 2B, and 2C, the Z2-axis direction parallel to the introduction-extraction direction, and the rotational direction of each axis of X2, Y2, and Z2. Thus, followability with respect to the receptacle terminals 2A, 2B, and 2C can be improved.

The first receptacle spring portion 43 is provided with the first receptacle contact connection portion 50 connected to the receptacle contact portion 22. Furthermore, the second receptacle spring portion 44 has the receptacle slit 52 extending in the direction crossing the introduction-extraction direction, and includes the first extension portion 53, the second extension portion 54, and the first return portion 55 due to the receptacle slit 52. In such a manner, the second receptacle spring portion 44 has the receptacle slit 52 extending in the direction crossing the introduction-extraction direction, and thus a displacement amount of the receptacle contact portion 22 by the second receptacle spring portion 44 can be increased.

In the receptacle terminals 2A and 2C, the first receptacle spring portion 43 is provided with the third extension portion 51 extending in the direction crossing the introduction-extraction direction, including one end connected to the other end of the second extension portion 54, and being connected to the receptacle substrate connection portion 21. In this way, the first receptacle elastic portion 23 can extend from the first receptacle spring portion 43 to the second receptacle spring portion 44 doubly, and thus a displacement amount by deformation of the first receptacle elastic portion 23 can be increased.

Further, in the receptacle terminal 2B, the second receptacle spring portion 44 includes the fourth extension portion 56 connected to the receptacle substrate connection portion 21, and the second return portion 57 that couples, in the introduction-extraction direction, the other end of the second extension portion 54 to one end of the fourth extension portion 56 facing the other end. In this way, a configuration of the second receptacle spring portion 44 can have a meander shape, and thus a displacement amount by deformation of the second receptacle spring portion 44 can be increased.

In the receptacle terminals 2A, 2B, and 2C, the first receptacle elastic portion 23 and the second receptacle elastic portion 24 are disposed in a point symmetry with the receptacle contact portion 22 as the center when viewed from the introduction-extraction direction. In this way, even when the receptacle contact portion 22 deviates from the receptacle substrate connection portion 21, and the first receptacle elastic portion 23 and the second receptacle elastic portion 24 are deformed, stress on both of the first receptacle elastic portion 23 and the second receptacle elastic portion 24 can be made equal.

In the receptacle terminals 2A, 2B, and 2C, the receptacle contact portion 22 includes the first contact 40 that contacts the plug contact portion 12 of the plug terminal 1, and the second contact 41 that is disposed to face the first contact 40 and sandwiches a contact of the plug terminal 1 with the first contact 40. In such a manner, the plug contact portion 12 of the plug terminal 1 is sandwiched between the first contact 40 and the second contact 41, and the contact state can be made reliable. The first contact 40 is connected to the first receptacle elastic portion 23, and the second contact 41 is connected to the second receptacle elastic portion 24.

The receptacle terminals 2A, 2B, and 2C include the regulating portion 42 that regulates an increase in a gap between the first contact 40 and the second contact 41. In this way, the first contact 40 and the second contact 41 can reliably sandwich the plug contact portion 12 of the plug terminal 1.

In the receptacle terminals 2A, 2B, and 2C, the regulating portion 42 is bent in a recessed shape in the direction closer to the receptacle substrate connection portion 21. In this way, the regulating portion 42 can be prevented from interfering with the plug contact portion 12 of the plug terminal 1.

Note that a plurality of the plug terminals 1 may be mounted on the first substrate 3 and a plurality of the receptacle terminals 2A, 2B, and 2C may be mounted on the second substrate 4. In this case, the plug terminal 1 and the receptacle terminals 2A, 2B, and 2C can absorb a position deviation due to an error in a mounting position of the plug terminal 1 and the receptacle terminals 2A, 2B, and 2C on the first substrate 3 and the second substrate 4 by elastic deformation of the first plug elastic portion 13, the second plug elastic portion 14, the first receptacle elastic portion 23, and the second receptacle elastic portion 24, and can achieve an excellent connection between the terminals.

Note that, in the plug terminal 1 and the receptacle terminals 2A, 2B, and 2C, according to the embodiments described above, the virtual first solid C1 and the virtual second solid C2 are assumed to be rectangular parallelepiped. However, the present disclosure is not limited to this. The first solid C1 or the second solid C2 may be a prism other than a quadrangular prism such as a triangular prism or a pentagonal prism, may be a cylinder, or may have a shape combining a cylinder and a prism. In a case of a cylinder, the first plug side surface S11 to the fourth plug side surface S14 of the first solid C1 and the first receptacle side surface S21 to the fourth receptacle side surface S24 of the second solid C2 may have a cylindrical side surface as a whole.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-32318, filed on Mar. 3, 2022, the entire disclosure of which is incorporated by reference herein.

### INDUSTRIAL APPLICABILITY

The present disclosure can be applied to a terminal mounted on a substrate.

### REFERENCE SIGNS LIST

1 Plug terminal (terminal)
2A, 2B, 2C Receptacle terminal (other terminal)
3 First substrate (substrate)
4 Second substrate (substrate)
11 Plug substrate connection portion (substrate connection portion)
11a Plug positioning portion
12 Plug contact portion (contact portion)
13 First plug elastic portion (first elastic portion)
14 Second plug elastic portion (second elastic portion)
15 Plug contact connection portion (contact connection portion)
17 First plug connection portion
18 Second plug connection portion
21 Receptacle substrate connection portion
21a Receptacle positioning portion
22 Receptacle contact portion
23 First receptacle elastic portion
24 Second receptacle elastic portion
30 First plug spring portion (first spring portion)
31 Second plug spring portion (second spring portion)
32 First coupling portion
33 Third plug spring portion (third spring portion)
34 Fourth plug spring portion (fourth spring portion)
35 Second coupling portion
36 Plug slit (slit)
37 First connection portion
38 Second connection portion
40 First contact (contact)
41 Second contact (contact)
42 Regulating portion
43 First receptacle spring portion
44 Second receptacle spring portion
45 Third receptacle spring portion
46 Fourth receptacle spring portion
47 Fifth receptacle spring portion
48 Sixth receptacle spring portion
50 First receptacle contact connection portion
51 Third extension portion
52 Receptacle slit
53 First extension portion
54 Second extension portion
55 First return portion
56 Fourth extension portion
57 Second return portion
60 Second receptacle contact connection portion
61 Seventh extension portion
62 Receptacle slit
63 Fifth extension portion
64 Sixth extension portion
65 Third return portion
66 Eighth extension portion
67 Fourth return portion
71 Ninth extension portion
72 Tenth extension portion
73 Fifth return portion
74 Eleventh extension portion
75 Twelfth extension portion
76 Sixth return portion
B11, B12 Plug plane figure (plane figure)
B21, B22 Receptacle plane figure
C1 First solid (solid)
C2 Second solid
S11 First plug side surface (first side surface)
S12 Second plug side surface (second side surface)
S13 Third plug side surface (third side surface)
S14 Fourth plug side surface (fourth side surface)
S21 First receptacle side surface
S22 Second receptacle side surface
S23 Third receptacle side surface
S24 Fourth receptacle side surface

1. A terminal made of a conductive material, the terminal comprising:
a substrate connection portion connected to a substrate;
a contact portion that contacts a contact of other terminal being introduced and extracted in an introduction-extraction direction crossing a main surface of the substrate; and
a first elastic portion that connects the substrate connection portion and the contact portion,
wherein the first elastic portion includes
a first spring portion that is provided along a first side surface being a part of side surfaces of a virtual solid having, as a plane surface or a bottom, a plane figure containing the contact portion when viewed from the introduction-extraction direction, and that is deformable with respect to the first side surface,
a second spring portion that is provided along a second side surface being a part of the side surfaces of the solid and having a different normal direction from the first side surface, and that is deformable with respect to the second side surface, and
a first coupling portion that couples the first spring portion to the second spring portion.

2. The terminal according to claim 1, further comprising
a second elastic portion that connects the substrate connection portion and the contact portion,
wherein the second elastic portion includes
a third spring portion that is provided along a third side surface being a part of the side surfaces of the solid and facing the first side surface, and that is deformable with respect to the third side surface,
a fourth spring portion that is provided along a fourth side surface being a part of the side surfaces of the solid and facing the second side surface, and that is deformable with respect to the fourth side surface, and
a second coupling portion that couples the third spring portion to the fourth spring portion.

3. The terminal according to claim 2, further comprising a contact connection portion that connects the first elastic portion and the second elastic portion to the contact portion,
wherein the contact connection portion is divided into a first connection portion connected to the first elastic portion and a second connection portion connected to the second elastic portion by a slit extending from the substrate connection portion toward the contact portion along the introduction-extraction direction.

4. The terminal according to claim 2, wherein the first elastic portion and the second elastic portion are disposed in a point symmetry with the contact portion as the center when viewed from the introduction-extraction direction.

5. The terminal according to claim 4, wherein the terminal has an S-shape when viewed from the introduction-extraction direction.

6. The terminal according to claim 3, wherein the first elastic portion and the second elastic portion are disposed in a point symmetry with the contact portion as the center when viewed from the introduction-extraction direction.

7. The terminal according to claim 6, wherein the terminal has an S-shape when viewed from the introduction-extraction direction.
